(19) United States
(12) Patent Application Publication
(10) Pub. No.: US 2011/0131143 A1
(43) Pub. Date: Jun. 2, 2011

(54) Patent-Product Information Distribution Systems and Methods

(76) Inventors: James MALACKOWSKI, Chicago, IL (US); Jason Cohen, Chicago, IL (US)

(21) Appl. No.: 12/727,939

(22) Filed: Mar. 19, 2010

Related U.S. Application Data
(63) Continuation-in-part of application No. 12/628,520, filed on Dec. 1, 2009.

(51) Int. Cl. G06Q 50/00; G06Q 10/00; G06F 17/30

(52) U.S. Cl. 705/310; 707/802; 707/E17.005

(57) ABSTRACT

Systems and methods for managing and distributing patent-product information are presented herein. The systems and method may facilitate the exchange of patent-product information, by performing the steps of: a) receiving patent-product information from a plurality of users; b) storing the patent-product information in a patent-product database on a server, in accordance with an input hierarchy; c) receiving a demand query from a public user, based on an identification marker; d) searching the patent-product database and obtaining patent-product information responsive to the public user's demand query; and e) delivering the obtained patent-product information to the public user. The systems and methods also provide for automatically issuance of an alert to a previously-specified recipient at a previously-specified time before expiration of a patent associated with the patent-product information.

### CROSS-REFERENCE TO RELATED APPLICATIONS

This application is a continuation-in-part of U.S. patent application Ser. No. 12/628,520, filed Dec. 1, 2009, which is incorporated by reference herein in its entirety.

### BACKGROUND

1. Field

The embodiments disclosed herein are related to systems and methods of providing patent-product information. More specifically, the embodiments disclosed herein are related to systems and methods for managing and distributing patent information related to corresponding products.

2. Background Art

United States patent law, under 35 U.S.C. §287, provides limitations on damages available to a patentee whose patent is infringed. Specifically, 35 U.S.C. §287(a) states:
Patentees, and persons making, offering for sale, or selling within the United States any patented article for or under them, or importing any patented article into the United States, may give notice to the public that the same is patented, either by fixing thereon the word “patent” or the abbreviation “pat.”, together with the number of the patent, or when, from the character of the article, this cannot be done, by fixing to it, or to the package wherein one or more of them is contained, a label containing a like notice. In the event of failure so to mark, no damages shall be recovered by the patentee in any action for infringement, except on proof that the infringer was notified of the infringement and continued to infringe thereafter, in which event damages may be recovered only for infringement occurring after such notice. Filing of an action for infringement shall constitute such notice.

In essence, a patentee who makes, offers for sale, sells within the U.S., or imports into the U.S., any patented article, must provide the public with notice that such article (i.e., product) is patented before he is entitled to recover damages (i.e., money) for any acts of infringement. The statute mandates that the patentee provide the requisite notice in one of two forms: 1) actual notice; or 2) constructive notice. A patentee can provide “actual notice” by identifying an infringer and notifying the identified infringer that the product is protected by a patent. After providing actual notice, the patentee is entitled to collect damages on any infringement that occurs after he has provided such actual notice.

Alternatively, a patentee can provide “constructive notice” by fixing a “patent mark” on all patented products that the patentee makes, offers for sale, sells within the U.S., or imports into the U.S. The patentee is then entitled to collect damages on any infringement that occurs after he has fixed a patent mark on the patented product; regardless of whether he identifies and provides actual notice to an infringer.

In practice, however, compliance with the patent marking mandates of 35 U.S.C. §287 can be cumbersome and commercially unacceptable; particularly when a product is covered by multiple patents. For example, small electronics, such as digital music players, may be covered by dozens of patents. Labeling or marking such small electronics with dozens of patents, in order to comply with 35 U.S.C. §287, can turn the product into a commercially unsellable product. Further, as additional patents issue/expire, updating the manufacturing process to add/subtract patent markings may become commercially unfeasible.

These compliance difficulties leave patentees with a catch-22 scenario. The patentee can either mark his products, regardless of the commercial consequence, or sell his products unmarked and forgo the accumulation of damages for infringing acts up until the patentee identifies an infringer and provides the infringer with actual notice of infringement. If the patentee chooses the latter, the patentee is forced to always be on the lookout for infringers.

Patentees therefore have an interest in an alternative system for providing the public with a form of constructive notice. Likewise, the public has an interest in knowing what products are protected by patents.

### BRIEF SUMMARY

Systems and methods for managing and distributing patent-product information are presented herein. In an embodiment, the systems and methods facilitate the exchange of patent-product information by performing the steps of: a) receiving patent-product information from a plurality of users; b) storing the patent-product information in a patent-product database on a server, in accordance with an input hierarchy; c) receiving a demand query from a public user, based on an identification marker; d) searching the patent-product database and obtaining patent-product information responsive to the public user's demand query; and e) delivering the obtained patent-product information to the public user.

Further features and advantages of the disclosed embodiments, as well as the structure and operation of the various embodiments, are described in detail below with reference to the accompanying figures. It is noted that the invention is not limited to the specific embodiments described herein. Such embodiments are presented herein for illustrative purposes only. Additional embodiments will be apparent to a person skilled in the pertinent art based on the teachings contained herein.

### BRIEF DESCRIPTION OF THE FIGURES

FIG. 1 is a high-level schematic drawing illustrating the relationships between the parties that partake in the presented methods.

FIG. 2 is a flowchart illustrating an input hierarchy in accordance with one embodiment presented herein.

FIG. 3 is a flowchart illustrating an embodiment described herein.

FIG. 4 is a schematic drawing of a model computer system used to implement the methods presented herein.

### DETAILED DESCRIPTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The above-identified limitations to 35 U.S.C. §287 can be addressed by usage of the systems and methods disclosed herein. More specifically, the inventors have developed systems and methods to aid a patentee in complying with the general objective of providing a form of “constructive notice” that a product is protected by one or more patents.

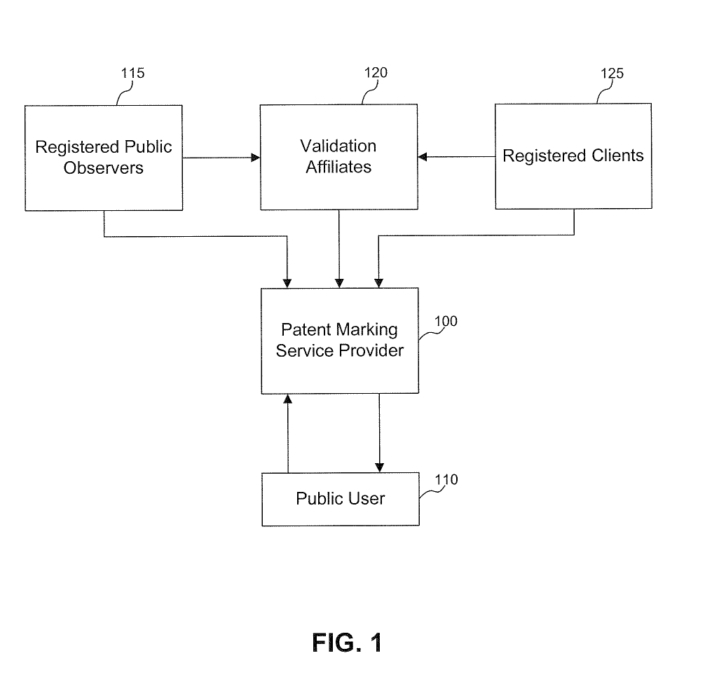

FIG. 1 is a high-level schematic drawing illustrating the relationships between the parties that partake in the presented methods. The arrows of FIG. 1 are representative of the transmission of patent-product information. A patent marking service provider 100 acts as the central control unit, which receives, organizes, and processes the information and demand queries initiated by the various parties. The patent marking service provider 100 also maintains and manages a dedicated server, which stores a patent-product database, as further described below. The terms “dedicated server” or “server,” as used herein, should not be limited to a singular system, but instead should include a variety of equivalent systems that function to provide storage of patent-product information and means for search and retrieval of the patent-product information.

In the embodiment shown, a public user 110 (e.g., an interested affiliated or unaffiliated third-party) can access patent-product information stored and maintained by the patent marking service provider 100. The public user 110 is provided such access via web-based communications (such as a dedicated website), telephone communications, mobile-based applications, or any other equivalent communication means. The public user 110 can run one or more demand queries on the patent-product database based on one or more identification markers. Identification markers can include, for example and without limitation: a product manufacturer (or company) name, content status, product description, model number, patent number, product name, stock-keeping unit identifier (SKU), a universal product code (UPC), etc.

For example, the public user 110 can access a website maintained by (or for) the patent marking service provider 100. At the website, the public user 110 can enter an identification marker in a general search field or in an advanced search field. The advanced search field differs from the general search field in that it provides additional search-protocol options for a more selective and targeted demand query on the patent-product database. Upon entering the one or more appropriate identification markers in the website's search field, a demand query can then be transmitted to the patent marking service provider 100. Upon receipt of the demand query, the patent marking service provider 100 performs a search on the patent-product database and returns to the public user 110 patent-product information responsive to the demand query. The patent-product information can include one or more of, or any combination of, the following examples, without limitation: a product manufacturer (or company) name, content status, product description, model number, patent number, product name, SKU, UPC, company financial information, patent licensing information, patent rating, company contact information, patent litigation information, images of the product, product advertisements, public comment, etc.

The “content status,” can include information such as recent updates to the patent-product database, etc. Product description can include information such as product usage, industry, size, costs, etc. Company financial information can include information such as revenue, earnings, market capitalization, etc. Patent licensing information can include information such as availability of licensing, licensing terms, royalty rates, exclusivity of licensing, etc. Patent rating can include information such as patent strength, patent breadth, etc. An example of patent rating information is described in U.S. Pat. No. 6,556,992, the disclosure of which is incorporated herein by reference, in its entirety. Company contact information can include information such as mailing addresses, e-mail addresses, telephone numbers, facsimile numbers, etc. Patent litigation information can include information such as the existence, status, outcome of any litigations related to the product and/or patents that protect the product, etc. Images of the product can include client-uploaded or user-uploaded images of the product. Product advertisements can include brochures, videos, testimonials, etc. Public comment can include blog entries, recommendations, customer reviews, etc. The above-listed categories of information and associated example data points are not exclusive. In other words, the above-listed categories of information should include one or more of the listed example data points, and equivalents thereto.

The patent marking service provider 100 maintains a patent-product database, cataloging the patent-product information, on the server based on an established input hierarchy. In an embodiment, the input hierarchy serves as a protocol for managing information (or data) entry provided by at least three sources: 1) registered public observers 115; 2) validation affiliates 120; and 3) registered clients 125. Each source (e.g., registered public observers 115, validation affiliates 120, and registered clients 125) is allowed to enter patent-product information into the patent-product database in accordance with pre-set entry parameters.

Registered public observers 115 can include unaffiliated members of the public 110 who create a registered relationship with the patent marking service provider 100. Registered public observers 115 provide their observations of patent-product information for commercially available products via, for example, a website. A registered public observer 115 may be, for example, an individual who becomes aware that a commercially available product is protected by a patent. The registered public observer 115 can provide the patent marking service provider 100 with information about the product. In this fashion, registered public observers 115 can aid the patent marking service provider 100 in developing a comprehensive patent-product database with information on a broad range of products. In some embodiments, however, the patent marking service provider 100 may set entry parameters to limit the amount, type, and/or availability of information that a registered public observer 115 can submit to the patent-product database. For example, the patent marking service provider 100 may limit the registered public observer's 115 entry parameters to one or more of, or a combination of, specific patent-product information types, such as: a product manufacturer (or company) name, model number, patent number, product name, SKU, UPC, images of the product, public comment, etc.

Validation affiliates 120 can include one or more third-party affiliates that are tasked by the patent marking service provider 100 to collect patent-product information and submit the patent-product information to the patent-product database. Validation affiliates 120 can include, for example and without limitation, law firms, intellectual property specialists, etc. Validation affiliates 120 can collect patent-product information from registered public observers 115, registered clients 125, and/or via independent investigation. In one embodiment, the validation affiliates 120 ensure the quality of the patent-product database by fact-checking the patent-product information. In this fashion, validation affiliates 120 also serve to aid the patent marking service provider 100 in developing a comprehensive patent-product database with information on a broad range of products. In some embodiments, however, the patent marking service provider 100 may set entry parameters to limit the amount, type, and/or availability of information that a validation affiliate 120 can submit to the patent-product database. For example, the patent marking service provider 100 may limit a validation affiliate's 120 entry parameters to one or more of, or a combination of, specific patent-product information types, such as: a product manufacturer (or company) name, content status, product description, model number, patent number, product name, SKU, UPC, company financial information, patent licensing information, patent rating, company contact information, patent litigation information, images of the product, etc.

Registered clients 125 may generally include, for example and without limitation, product manufacturers, sellers, and importers who create a paid (subscription or otherwise) relationship with the patent marking service provider 100. The registered clients' 125 interests are to participate in a system that meets the aims of 35 U.S.C. §287, in a commercially viable manner. Therefore, registered clients 125 provide patent-product information to the patent marking service provider 100, either directly or through the validation affiliates 120. In some embodiments, however, the patent marking service provider 100 may set entry parameters to limit the amount, type, and/or availability of information that a registered client 125 can submit to the patent-product database. For example, the patent marking service provider 100 may limit a registered client's 125 entry parameters to one or more of, or a combination of, specific patent-product information types, such as: a product manufacturer (or company) name, content status, product description, model number, patent number, product name, SKU, UPC, company financial information, patent licensing information, patent rating, company contact information, patent litigation information, images of the product, product advertisements, etc.

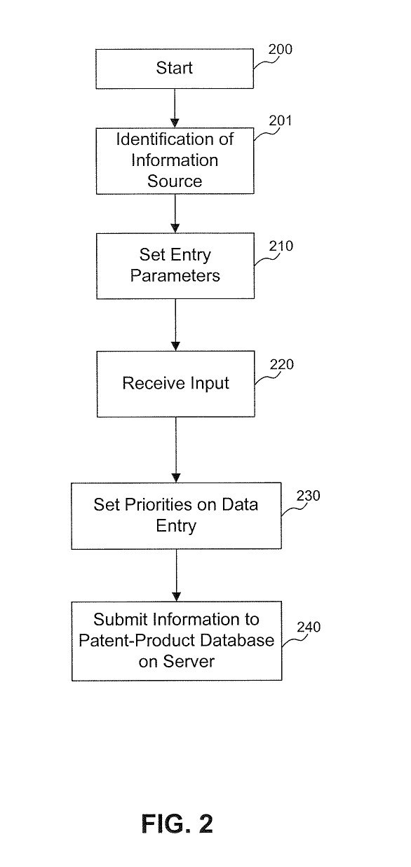

FIG. 2 is a flowchart illustrating an input hierarchy, in accordance with one embodiment presented herein, for entry of patent-product information in the patent-product database. Upon inception 200, the method immediately proceeds to step 201 wherein the source of the patent-product information is identified. Step 201 can be executed by providing the source (e.g., registered public observers 115, validation affiliates 120, and registered clients 125) with a username, password, or equivalent identification means. In practice, the source is presented with a prompt, for example on a website, to enter their personal identification information. As such, the patent marking service provider 100 can identify where the patent-product information is originating. Entry parameters are then set in step 210 based on the identification of the source; for example and without limitation, whether from registered public observers 115, validation affiliates 120, or registered clients 125. The entry parameters establish, for example, what amount, type, and/or availability of information the source can submit to the patent-product database. In step 220, the patent-product information is received in accordance with the entry parameters. In step 230, the patent marking service provider 100 establishes priorities on data entry. For example, the patent marking service provider 100 may choose to give patent-product information provided by a registered client 125 priority over patent-product information provided by validation affiliates 120 or registered public observers 115. Alternatively, the patent marking service provider 100 may choose to give patent-product information provided by the validation affiliates 120 priority over patent-product information provided by registered clients 125 or registered public observers 115. In this way, the patent marking service provider 100 can ensure the integrity of the system. In step 240, the patent-product information is submitted and stored in the patent-product database on the server.

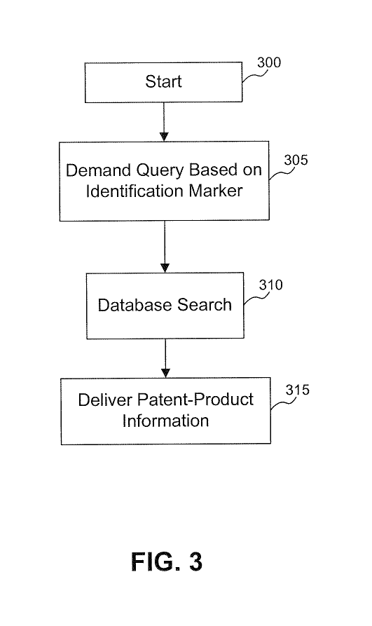

FIG. 3 is a flowchart illustrating a demand query process, in accordance with one embodiment presented herein. Upon inception 300, the method immediately proceeds to step 305, wherein a public user 110 runs a demand query on the patent-product database based on an identification marker. This may involve, for example, entering identification information into a search field on a website. In step 310, the patent marking service provider 100 receives the demand query and performs a search on the patent-product database. In step 315, the results of the search are delivered to the public user 110. The results can be delivered to the public user 110 via an electronic or written report, a display on a screen, or other equivalent means.

In one embodiment, the patent marking service provider 100 also establishes and maintains an alert and update protocol. In such embodiment, the patent marking service provider 100 updates the patent-product database when patents covering associated products either issue or expire. Alerts can be sent to public users 110, registered public observers 115, validation affiliates 120, and/or registered clients 125. Alerts can be sent by way of e-mails, text messages, telephone calls, facsimile, postal mail, or equivalent means.

In an embodiment, the alerts are automatically provided by patent marking service provider 100. Alternatively or additionally, custom alerts may be set by any of public users 110, registered public observers 115, validation affiliates 120, and registered clients 125. For example, a registered client 125 may request that an alert be sent to one or more specified persons at registered client 125 at a specified time before a patent expires. The one or more specified persons may be, for example, at least one of marketing personnel, legal personnel, or manufacturing personnel. The alert can then be automatically sent to the specified person(s) by patent marking service provider 100 at the specified time. In this manner, registered client 125 can begin the process to update the product markings once the alert has been received so as to avoid falsely marking a product once the associated patent has expired.

The presented methods, or any part(s) or function(s) thereof, may be implemented using hardware, software or a combination thereof and may be implemented in one or more computer systems or other processing systems, such that no human operation is necessary. Rather, the methods described herein can be performed entirely automatically through machine operations. Useful machines for performing the operation of the methods include general purpose digital computers or similar devices.

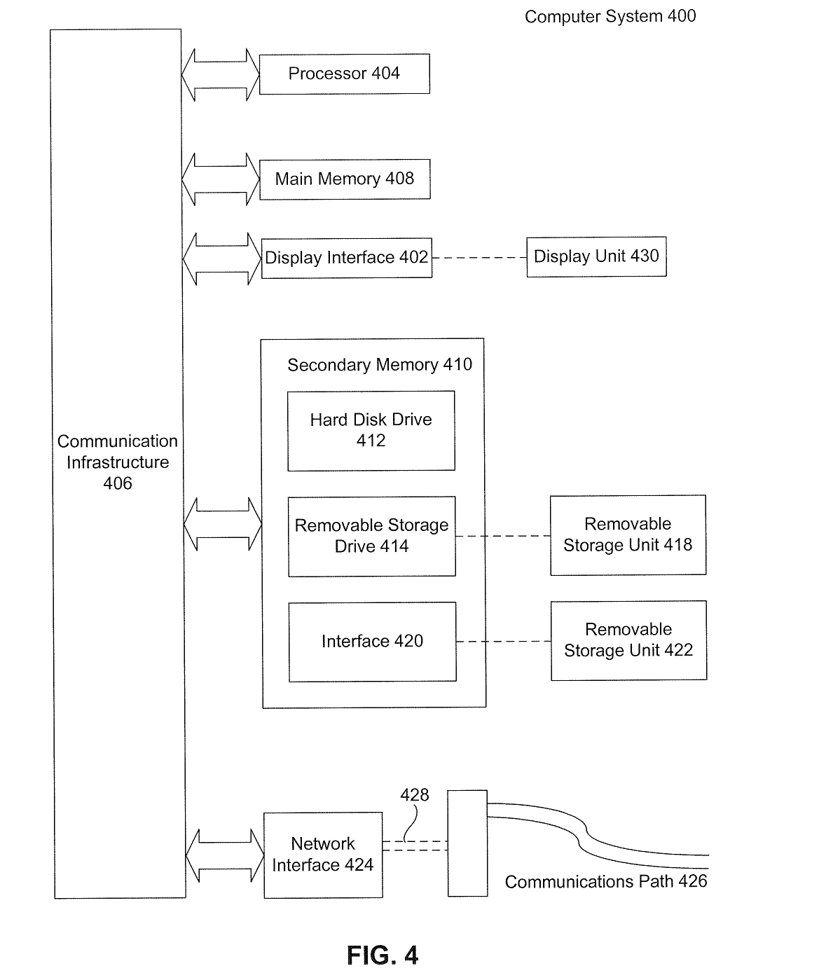

In fact, in one embodiment, one or more computer systems may carry out the functionality described herein. An example of a computer system is shown in FIG. 4.

FIG. 4 shows a computer system 400 having one or more processors, such as processor 404. The processor 404 is connected to a communication infrastructure 406 (e.g., a communications bus, cross-over bar, or network). Computer system 400 can include a display interface 402 that forwards graphics, text, and other data from the communication infrastructure 406 (or from a frame buffer not shown) for display on the display unit 430.

Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well known manner. Removable storage unit 418 represents a floppy disk, magnetic tape, optical disk, etc. which is read by and written to by removable storage drive 414. As will be appreciated, the removable storage unit 418 includes a computer usable storage medium having stored therein computer software and/or data.

In alternative embodiments, secondary memory 410 may include other similar devices for allowing computer programs or other instructions to be loaded into computer system 400. Such devices may include, for example, a removable storage unit 418 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 418 and interfaces 420, which allow software and data to be transferred from the removable storage unit 418 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 414 and a hard disk installed in hard disk drive 412. These computer program products provide software to computer system 400. Embodiments of the systems and methods presented herein include such computer program products.

Computer programs (also referred to as computer control logic) are stored in main memory 408 and/or secondary memory 410. Computer programs may also be received via communications interface 424. Such computer programs, when executed, enable the computer system 400 to perform the methods presented herein. In particular, the computer programs, when executed, enable the processor 404 to perform the features of the presented methods. Accordingly, such computer programs represent controllers of the computer system 700.

In an embodiment where the methods are implemented using software, the software may be stored in a computer program product and loaded into computer system 400 using removable storage drive 414, hard drive 412 or communications interface 424. The control logic (software), when executed by the processor 404, causes the processor 404 to perform the functions and methods described herein.

In another embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

### EXAMPLES

### Example 1

In one example embodiment, there is provided a method of facilitating the exchange of patent-product information, comprising: a) receiving patent-product information from a plurality of users; b) storing the patent-product information in a patent-product database on a server, in accordance with an input hierarchy; c) receiving a demand query from a public user, based on an identification marker; d) searching the patent-product database and obtaining patent-product information responsive to the public user's demand query; and e) delivering the obtained patent-product information to the public user. In such method, the plurality of users can be selected from a group consisting of: registered observers, validation affiliates, and registered clients. In one embodiment, the input hierarchy is: a) registered clients, b) validation affiliates, and then c) registered observers. In another embodiment, the input hierarchy is: a) validation affiliates, b) registered clients, and then c) registered observers. The identification marker can be selected from a group consisting of: company name, content status, product description, model number, patent number, product name, SKU, and UPC. The patent-product information can be selected from a group consisting of: company name, content status, product description, model number, patent number, product name, SKU, UPC, company financial information, patent licensing information, patent rating, company contact information, patent litigation information, images of the product, product advertisements, and public comment. In one embodiment, the method includes delivering an update alert when the patent-product database is updated. In another embodiment, the method includes automatically issuing an alert to a previously-specified recipient at a previously-specified time before expiration of a patent associated with the patent-product information.

### Example 2

In a second example embodiment, there is provided a computer-based system for facilitating the exchange of patent-product information, comprising: a) a server for storing a patent-product database; and b) a processor coupled to the server, the processor programmed in accordance with an input hierarchy, wherein a plurality of users can enter patent-product information into the patent-product database in accordance with the input hierarchy. The processor is further programmed to receive a demand query from a public user, based on an identification marker. The processor is also programmed to execute a search protocol to search the patent-product database and obtain patent-product information responsive to the public user's demand query. The processor is further programmed to deliver the obtained patent-product information to the public user. In such system, the plurality of users can be selected from a group consisting of: registered observers, validation affiliates, and registered clients. In one embodiment, the input hierarchy is: a) registered clients, b) validation affiliates, and then c) registered observers. In another embodiment, the input hierarchy is: a) validation affiliates, b) registered clients, and then c) registered observers. The identification marker can be selected from a group consisting of: company name, content status, product description, model number, patent number, product name, SKU, and UPC. The patent-product information can be selected from a group consisting of: company name, content status, product description, model number, patent number, product name, SKU, UPC, company financial information, patent licensing information, patent rating, company contact information, patent litigation information, images of the product, product advertisements, and public comment. In one embodiment, the system delivers an update alert when the patent-product database is updated. In another embodiment, the system automatically issues an alert to a previously-specified recipient at a previously-specified time before expiration of a patent associated with the patent-product information.

### Example 3

In another example, there is provide a computer program product comprising a computer useable medium having computer readable program code functions embedded in the medium for causing a computer to facilitate the exchange of patent-product information, comprising: a) a first computer readable program code function that causes the computer to receiving patent-product information from a plurality of users; b) a second computer readable program code function that causes the computer to store the patent-product information in a patent-product database on a server, in accordance with an input hierarchy; c) a third computer readable program code function that causes the computer to receive a demand query from a public user, based on an identification marker; d) a fourth computer readable program code function that causes the computer to search the patent-product database and obtain patent-product information responsive to the public user's demand query; and e) a fifth computer readable program code function that cause the computer to deliver the obtained patent-product information to the public user. In such computer program product, the plurality of users can be selected from a group consisting of: registered observers, validation affiliates, and registered clients. In one embodiment, the input hierarchy is: a) registered clients, b) validation affiliates, and then c) registered observers. In another embodiment, the input hierarchy is: a) validation affiliates, b) registered clients, and then c) registered observers. The identification marker can be selected from a group consisting of: company name, content status, product description, model number, patent number, product name, SKU, and UPC. The patent-product information can be selected from a group consisting of: company name, content status, product description, model number, patent number, product name, SKU, UPC, company financial information, patent licensing information, patent rating, company contact information, patent litigation information, images of the product, product advertisements, and public comment. In one embodiment, the computer based system includes a computer readable program code function that causes the computer to deliver an update alert when the patent-product database is updated. In another embodiment, the computer based system includes computer readable program code function that causes the computer to automatically issue an alert to a previously-specified recipient at a previously-specified time before expiration of a patent associated with the patent-product information.

### Example 4

In yet another example, there is provided a method of facilitating the exchange of patent-product information, comprising: a) maintaining a server for storing a patent-product database; b) establishing an input hierarchy, wherein a plurality of users can enter patent-product information into the patent-product database in accordance with the input hierarchy; c) providing a query interface for a public user to make a demand query on the server based on an identification marker; d) providing a search protocol to search the patent-product database and obtain patent-product information responsive to the public user's demand query; and e) delivering the obtained patent-product information to the public user. In such method, a plurality of users can be selected from a group consisting of: registered observers, validation affiliates, and registered clients. In one embodiment, the input hierarchy is: a) registered clients, b) validation affiliates, and then c) registered observers. In an alternative embodiment, the input hierarchy is: a) validation affiliates, b) registered clients, and then c) registered observers. The identification marker can be selected from a group consisting of: company name, content status, product description, model number, patent number, product name, SKU, and UPC. The patent-product information can be selected from a group consisting of: company name, content status, product description, model number, patent number, product name, SKU, UPC, company financial information, patent licensing information, patent rating, company contact information, patent litigation information, images of the product, product advertisements, and public comment. In one embodiment, the method includes delivering an update alert when the patent-product database is updated. In another embodiment, the method includes automatically issuing an alert to a previously-specified recipient at a previously-specified time before expiration of a patent associated with the patent-product information.

### Example 5

In another example, there is provided a computer-based system for facilitating the exchange of patent-product information, comprising: a) a server for storing a patent-product database; and b) a processor coupled to the server, the processor maintaining an input hierarchy, wherein a plurality of users can enter patent-product information into the patent-product database in accordance with the input hierarchy. The processor is adapted to receive a demand query, from a public user, based on an identification marker. The processor is also adapted to execute a search protocol to search the patent-product database and obtain patent-product information responsive to the public user's demand query. The processor is also adapted to deliver the obtained patent-product information to the public user. In such a computer-based system, the plurality of users can be selected from a group consisting of: registered observers, validation affiliates, and registered clients. The identification marker can be selected from a group consisting of: company name, content status, product description, model number, patent number, product name, SKU, and UPC. The patent-product information can be selected from a group consisting of: company name, content status, product description, model number, patent number, product name, SKU, UPC, company financial information, patent licensing information, patent rating, company contact information, patent litigation information, images of the product, product advertisements, and public comment. In one embodiment, input hierarchy is: a) registered clients, b) validation affiliates, and then c) registered observers. In an alternative embodiment, the input hierarchy is: a) validation affiliates, b) registered clients, and then c) registered observers. In one embodiment, the system delivers an update alert when the patent-product database is updated. In another embodiment, the system automatically issues an alert to a previously-specified recipient at a previously-specified time before expiration of a patent associated with the patent-product information.

1. A method of facilitating the exchange of patent-product information, comprising:
receiving, by a processor, patent-product information from a plurality of users, each user in the plurality of users associated with one of a plurality of source types;
establishing, by the processor, a priority for a piece of patent-product information according to an input hierarchy and the source type associated with the user from whom the piece of patent-product information was received, the input hierarchy identifying a priority given to information received from a source type;
storing the patent-product information in a patent-product database on a server, in communication with the processor, in accordance with the established priorities;
delivering, by the processor, the patent-product information to a public user according to the established priority for the obtained patent-product information; and
automatically issuing an alert to a previously-specified recipient at a previously-specified time before expiration of a patent associated with the patent-product information.

2. The method of claim 1, wherein the plurality of users are selected from a group consisting of: registered observers, validation affiliates, and registered clients.

3. The method of claim 2, wherein the input hierarchy is: a) registered clients, b) validation affiliates, and then c) registered observers.

4. The method of claim 2, wherein the input hierarchy is: a) validation affiliates, b) registered clients, and then c) registered observers.

5. The method of claim 1, further comprising receiving a custom alert request from a user in the plurality of users, the custom alert request specifying at least one recipient to receive the alert and a time before expiration of the patent at which the alert should be issued.

6. The method of claim 1, wherein the patent-product information is selected from a group consisting of: company name, content status, product description, model number, patent number, product name, SKU, UPC, company financial information, patent licensing information, patent rating, company contact information, patent litigation information, images of the product, product advertisements, and public comment.

7. The method of claim 1, further comprising: delivering an update alert when the patent-product database is updated.

8. The method of claim 1, wherein the delivering comprises:
receiving a demand query from a public user, based on an identification marker;
searching the patent-product database and obtaining patent-product information responsive to the public user's demand query; and
delivering the obtained patent-product information to the public user according to the established priority for the obtained patent-product information.

9. A computer-based system for facilitating the exchange of patent-product information, comprising:
a server for storing a patent-product database; and
a processor coupled to the server, the processor programmed to establish a priority for a piece of patent-product information according to an input hierarchy and a source type associated with a user from whom the piece of patent-product information was received, the input hierarchy identifying a priority given to information received from the source type;
wherein the processor is further programmed to deliver the patent-product information to a public user according to the established priority for the obtained patent product information and automatically issue an alert to a previously-specified recipient at a previously-specified time before expiration of a patent associated with the patent-product information.

10. The computer-based system of claim 9, wherein the plurality of users are selected from a group consisting of: registered observers, validation affiliates, and registered clients.

11. The computer-based system of claim 10, wherein the input hierarchy is: a) registered clients, b) validation affiliates, and then c) registered observers.

12. The computer-based system of claim 10, wherein the input hierarchy is: a) validation affiliates, b) registered clients, and then c) registered observers.

13. The computer-based system of claim 9, wherein the processor is further programmed to receive a custom alert request from a user in the plurality of users, the custom alert request specifying at least one recipient to receive the alert and a time before expiration of the patent at which the alert should be issued.

14. The computer-based system of claim 9, wherein the patent-product information is selected from a group consisting of: company name, content status, product description, model number, patent number, product name, SKU, UPC, company financial information, patent licensing information, patent rating, company contact information, patent litigation information, images of the product, product advertisements, and public comment.

15. The computer based system of claim 9, wherein the processor is programmed to deliver an update alert when the patent-product database is updated.

16. A computer program product comprising a computer useable storage medium having computer readable program code functions embedded in the medium that, when executed by a computer, cause the computer to facilitate the exchange of patent-product information, comprising:
a first computer readable program code function that causes the computer to receiving patent-product information from a plurality of users, each user in the plurality of users associated with one of a plurality of source types;
a second computer readable program code function that causes the computer to establish a priority for a piece of patent-product information according to an input hierarchy and, the source type associated with the user from whom the piece of patent-product information was received, the input hierarchy identifying a priority given to information received from a source type;
a third computer readable program code function that causes the computer to store the patent-product information in a patent-product database on a server, in accordance with an input hierarchy;
a fourth computer readable program code that causes the computer to deliver the patent-product information to a public user according to the established priority for the obtained patent-product information; and
a fifth computer readable program code function that causes the computer to automatically issue an alert to a previously-specified recipient at a previously-specified time before expiration of a patent associated with the patent-product information.

17. The computer program product of claim 16, wherein the plurality of users are selected from a group consisting of: registered observers, validation affiliates, and registered clients.

18. The computer program product of claim 17, wherein the input hierarchy is: a) registered clients, b) validation affiliates, and then c) registered observers.

19. The computer program product of claim 17, wherein the input hierarchy is: a) validation affiliates, b) registered clients, and then c) registered observers.

20. The computer program product of claim 16, further comprising a sixth computer readable program code function that causes the computer to receive a custom alert request from a user in the plurality of users, the custom alert request specifying at least one recipient to receive the alert and a time before expiration of the patent at which the alert should be issued.

21. The computer program product of claim 16, wherein the patent-product information is selected from a group consisting of: company name, content status, product description, model number, patent number, product name, SKU, UPC, company financial information, patent licensing information, patent rating, company contact information, patent litigation information, images of the product, product advertisements, and public comment.

22. The computer program product of claim 16, further comprising a sixth computer readable program code function that causes the computer to deliver an update alert when the patent-product database is updated.
